(19) United States
(12) Patent Application Publication
(10) Pub. No.: US 2010/0223433 A1
(43) Pub. Date: Sep. 2, 2010

(54) Configurable object graph traversal with redirection for garbage collection

(75) Inventor: Tatu J. Ylonen, Espoo (FI)

Correspondence Address: TATU YLONEN OY, LTD., KUTOJANTIE 3, ESPOO, 02630, FI

(73) Assignee: Tatu Ylonen Oy Ltd, Espoo (FI)

(21) Appl. No.: 12/394,194

(22) Filed: Feb. 27, 2009

(51) Int. Cl. G06F 12/00

(52) U.S. Cl. 711/154; 711/E12.001

(57) ABSTRACT

A configurable object graph traversal component with redirection capability for use in garbage collectors and other related applications. The component may be implemented in either hardware or in software, and provides an interface that allows reuse of the same component for the various traversal tasks performed during garbage collection. The interface supports redirecting traversal to new copies of moved objects, updating referring cells, performing cycle detection efficiently, and in some embodiments also supports selecting the direction of traversal, handling exits from the traversed memory region specially, and providing access to the old address of copied cells.

### CROSS-REFERENCE TO RELATED APPLICATIONS

Not Applicable

### INCORPORATION-BY-REFERENCE OF MATERIAL SUBMITTED ON ATTACHED MEDIA

Not Applicable

### TECHNICAL FIELD

The present invention relates to traversing an object graph in a computer system, particularly to a component for traversing an object graph in a machine employing garbage collection in a computational device.

### BACKGROUND OF THE INVENTION

Garbage collectors, distributed object systems, persistent object stores, serialization methods, and a number of other mechanisms in a computer system must efficiently traverse an object graph in memory. The object graph is often cyclic, may comprise shared portions, may be distributed across multiple computing systems, etc. Many object types may be supported. For copying or compacting garbage collectors, the objects may be moved during tracing, and referring pointers may need to be updated.

Many ways of implementing such traversal are known in the garbage collection literature, including recursive, iterative, and work list based variants. An extensive survey of the garbage collection literature can be found in the book R. Jones and R. Lins: Garbage Collection: Algorithms for Dynamic Memory Management, Wiley, 1996, including descriptions of many algorithms for traversing (tracing) an object graph with or without copying. Significant newer work exists e.g. in the areas of lock-free work queues, work stealing, and parallelizing various garbage collection operations (including tracing). It is generally known how to implement such traversing mechanisms, though it seems likely that further improvements will still be made in this area.

High performance mechanisms for implementing serialization, distributed object systems and persistent object stores can benefit greatly from having low-level access to the object graph, at a level similar to that available to a garbage collector. Each of these systems generally uses traversal mechanisms that are similar to, but not identical, to the traversal performed by a garbage collector. Even within the garbage collection area, things such as SATB (snapshot-at-the-beginning) tracing for global garbage cycle detection, popular object garbage collection, nursery collection, older generation collection, and mature object space (containing objects having survived many generations) collection may all utilize slightly different mechanisms and require different actions to be performed during the traversal. Known garbage collection systems implement a dedicated object graph traversing mechanism wherever one is needed, or at least have very limited reuse of the same mechanism.

Many abstract data type libraries and graph manipulation libraries offer a generic mechanism for traversing a graph (whether cyclic or not). Known traversal mechanisms fall into two categories: those that call a given function for each object of the graph, and those that use an iterator object to store the context of the traversal, and provide functions for getting the first object and getting the next object using the iterator.

Known generic graph traversal mechanisms cannot, however, be used for garbage collection, because advanced garbage collection systems move (copy, compact) at least some objects during garbage collection and need to update pointers that refer to moved objects from other objects. No generic graph traversal interface that fills the requirements is known. (But as already noted, most garbage collectors contain highly specialized traversal mechanisms that are used to implement copying/moving/compacting.)

It would be desirable to have a single mechanism for performing object graph traversal that could be utilized wherever needed when implementing garbage collection and related operations. Such operations are extremely performance-critical, and have requirements that do not exist in general purpose graph manipulation systems.

### BRIEF SUMMARY OF THE INVENTION

An objective of the present invention is to define an interface that can be used to connect a single configurable traversal component to the various components that need traversal functionality in a computer system, whether implemented in hardware or in software.

One aspect of the invention is a configurable traversal component that provides such an interface and its embodiment in a computer system. It supports redirecting the traversal to new copies of objects, and provides mechanisms by which the referring pointers can be efficiently updated.

Another aspect of the invention is a method for performing traversal using such a component and a configuration object working through its interface.

Very few garbage collectors to date have been implemented in hardware to any substantial degree (except for read and write barriers, and specialized tag bit handling). Implementing the traversal and substantial other parts in hardware could be of interest especially for small, power-constrained devices that implement significant functionality in custom ASICs (Application Specific Integrated Circuits) anyway. The main motivation there would be reducing power consumption, as even though the processors on such systems may be fast enough to perform garbage collection without disruption, many orders of magnitude fewer logic gates will need to change state if the traversal and other common garbage collection operations are implemented using special hardware as dedicated state machines on an ASIC as opposed to a full software implementation. It is expected that power consumption will remain a major problem on such machines for many years as there is continuing pressure to make mobile devices smaller, lighter, more wearable, and to make their batteries last longer. Some of the tasks likely to be performed by future mobile devices, such as voice control, speech-to-text conversion, automatic translation and intelligent information analysis may be quite compute intensive and frequently utilize garbage collection.

In software, besides code size reduction (which is important in mobile devices), having only one instance of the traversal component allows better locality in the instruction cache (thus fewer external memory accesses, which reduces power consumption), simplifies maintenance of the software, makes it much easier to change or extend object layouts, and generally encourages using better algorithms in various parts of the system as they can be implemented without reimplementing the traversal functionality in each case (in practice, for example, many garbage collectors support popular objects but do not bother to implement their garbage collection, because of the significant work needed for building yet another traversal mechanism). Having a single implementation also makes it more cost-effective to optimize the traversal mechanism as far as possible.

### BRIEF DESCRIPTION OF THE SEVERAL VIEWS OF THE DRAWING(S)

FIG. 1 illustrates an embodiment of a configurable traversal component.

FIG. 2 illustrates the state machine of the configurable traversal component in one possible embodiment.

FIG. 3 illustrates a computer system comprising a configurable traversal component and several configuration components connected to it.

### DETAILED DESCRIPTION OF THE INVENTION

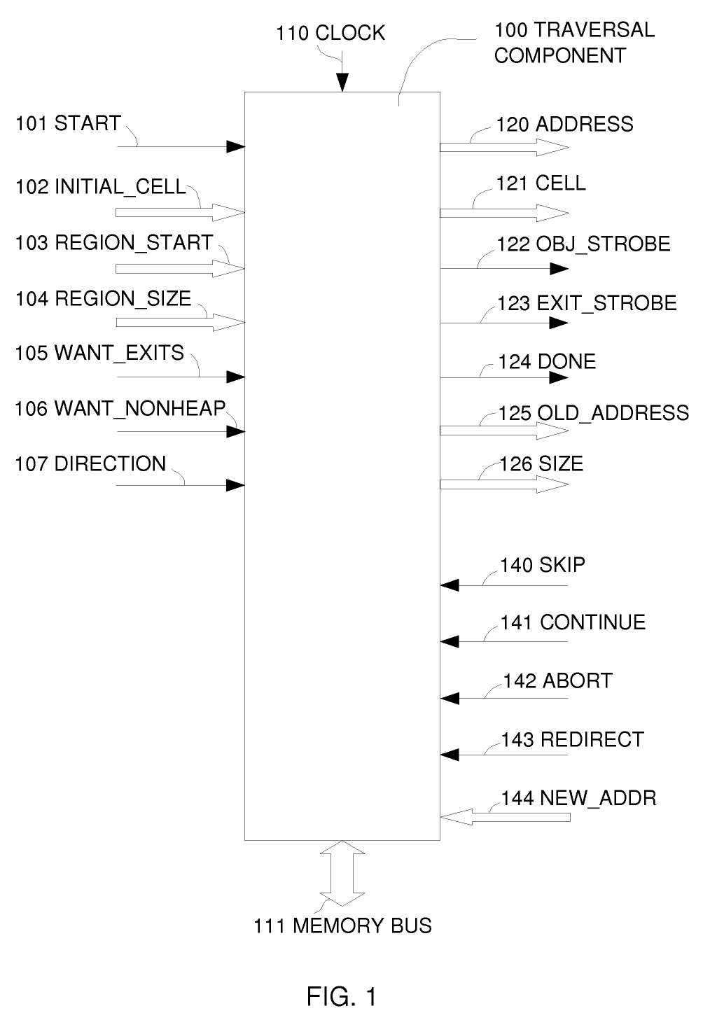

FIG. 1 illustrates an embodiment of a configurable traversal component (100) according to the present invention. (101) illustrates a means for starting the traversal. It could be implemented e.g. as a dedicated wire carrying a logic signal, or as a special code or packet transmitted or written over a control bus (any known bus architectures, serial or parallel, electrical or optical, synchronous or asynchronous, of any voltage or differentiality, proprietary or standard, could be used with the present invention). (102) illustrates a means for inputting the initial cell (or address of such cell) to the component (from some control logic that initiates the traversal). Cell here means something identifying an object; some cells may be self-contained (e.g., an integer with tag bits indicating it is an integer) or pointers to objects with descriptors. The type of the objects may be known a priori, or additional bits may be passed with an address to indicate the type of the object. The type may also be determined from the address. Essentially any known cell structure for garbage collected programming environments, whether boxed or not, may be used. Normally, the cell permits the component to determine the address of the initial object in memory.

(110) represents a clock input to the component. Preferably at least some of the control signals are synchronized to the clock; however, there may be more than one clock, such as a separate clock for the memory bus (111) that provides a means for reading information from the memory devices in which the object graph is stored. The memory bus may be any known memory bus, including e.g. interfaces to SRAM, SDRAM, DDR2, or DDR3. It may also be a standard bus that can be used to access memory, such as PCI, HyperTransport or QuickPath. The memory bus may connect directly to memory, or may connect to some kind of memory access arbitration logic or an interconnection fabric (e.g., PCI bridge or some kind of routing logic). In some embodiments the traversal component may itself contain a memory device that stores at least part of the object graph; at least in such cases the memory bus may also permit other components to access the memory within the traversal component. The memory bus may also be used to access a stack stored in a memory device; however, the stack may also be embedded in the traversal component.

The traversal component is intended to interface with one or more configuration components (configurators) that specify the actions to be performed for each object as it is traversed, and also controls various aspects of the traversal. In a hardware implementation it may be desirable to instantiate a single generic component (e.g. based on a VHDL or Verilog description) as multiple separate logic circuits in an ASIC, each instance with its own configuration component attached. Alternatively, the configurable traversal component may be instantiated once, and a known multiplexing mechanism used for passing the control signals between the traversal component and the appropriate configuration component at each time. (Intermediate variants are also possible.)

In the case of a software implementation, both approaches are clearly possible, but the latter would probably be preferable at least in environments where memory (code) space is limited, such as in mobile devices. In a software implementation much of the signaling could be implemented using function calls and/or callbacks, and the multiplexing could be performed using e.g. global variables, a thread-local context data structure, thread-local registers, and/or a thread-local stack. In a mixed software-hardware implementation the boundary between hardware and software could reside e.g. at the interface between the traversal component and the configuration component, or within either of these components. In an advantageous division the traversal and the most common operations performed during traversal (such as object marking and copying into an already allocated LAB) could be implemented in hardware, but e.g. the allocation of a new LAB (thread-local allocation buffer) implemented by a trap or interrupt that transfers control to software.

To be able to implement required garbage collection operations in a garbage collector that at least sometimes moves (copies, compacts) objects the configuration means must generally receive not only the current cell being traversed, but also the address of the memory location containing that cell (note that the cell may be self-contained or a pointer to an object). The address is needed for updating the referring pointer when the object is moved. (The update itself need not necessarily happen during the processing of that particular object by the configuration means.)

The interface for signaling from the traversal component to a configuration component comprises a means for passing the memory address of the cell currently being examined (120). It (and generally the other values being passed) may be passed e.g. using a parallel bus, a serial bus, some kind of messaging in a hardware implementation, or e.g. in a global variable, thread-local variable, stack, or preferably a register in a software implementation.

Since the traversal component needs to read and inspect the cell in many embodiments, it may read the contents of the cell before passing the address to the configuration means. In such embodiments the interface preferably also comprises a means for passing the cell itself (121) to the configuration means, so that it does not need to read it again.

The traversal component also has a means for indicating to the configuration component when the address (and cell, if applicable) is valid (122). In a message-oriented architecture this is naturally indicated by the receipt of a message also containing the address (a separate message could also be used). In an embodiment with a parallel bus this would most naturally be signaled by a logic signal (OBJ_STROBE) that switches to a particular logic value when the data lines are valid. In software, this is preferably indicated by the occurrence of a function call to the configuration component.

The traversal component also has a means for indicating when the traversal is complete (124). This is preferably a logic signal, but could also be e.g. a message. In a software implementation this situation would preferably be indicated by returning from a function implementing a generic traversal mechanism.

The configuration component has an interface for signaling some information back to the traversal component. In most embodiments the time needed by the configuration component for processing (e.g. copying) an object varies between objects. It thus has a means for indicating when the configuration component is done handling the current cell. It also has a means for indicating what to do with the object (whether to recurse into it, or whether to skip it). In the preferred embodiment, there is a means for indicating that traversing can continue by recursing into the current cell (141), and there is also a means for indicating that traversing can continue but the current cell should be skipped (140).

It is an essential element of the present invention that there also be a means for the configuration component to redirect the traversal to a cell other than the one received from the traversal component. In one embodiment, this is implemented by a separate address returning means (144) and a redirect indicator means (143); however, they can also be combined. With this mechanism, a configuration component that effects copying the objects can cause the traversal component to traverse the new copy of the object, and the memory address of the cell currently being examined can be used to update the referring pointers to objects referenced from the just copied object.

In software, it is preferable that the function implementing the configuration component returns a single value, where this value can be any of:
a special “skip the current cell” value, or
a new cell from which to continue traversing.

The special value could be e.g. a value with all bits set, or some other bit pattern that is not a valid cell in the particular system.

The new cell could be either the cell provided by the traversal component, or it could be some other cell, typically referring to the new copy of the object after copying it (possibly read from a forwarding pointer or an array containing new addresses). A pointer could also be returned instead of a cell.

In some embodiments other return values could also be used. For example, it would be possible to have the traversal component perform at least simple checking whether the cell is a heap cell and whether it points to within a region being currently traversed (as indicated e.g. by a start address and length), and have the configuration component provide two functions, an object function that is called for all heap cells within the region, and an exit function that is called for all heap cells pointing out from the region. The object function could have a special return value that causes the traversal component to call the exit function for the cell, even though it pointed to within the region (this could be useful e.g. for treating references to cells with more than one reference as exits, as may be desirable in garbage collectors that make use of trees of objects headed by an object with more than one reference, also called multiobjects in the co-owned application U.S. Ser. No. 12/147,419 by the same inventor; this reference also contains several code snippets that can serve as examples of configuration components).

In hardware the special values could be indicated for example by a separate logic signal, a flag in some packet, a special packet or message type, or by a special cell value as in software.

In many embodiments it is also desirable to have a means by which the configuration component can abort the traversal (142). This could be, e.g., a special logic signal, a special message type, or a special returned cell value.

In some embodiments the traversal component may offer additional control mechanisms. For example, it may accept as input the start address of a memory region to traverse (103) and the size of the area (104) (equivalently, e.g. start address and end address could be provided, as the size can be trivially computed as ‘end-start’); such inputs allow the traversal component to determine whether a heap cell points to within the memory region of interest, and it may e.g. only indicate such cells to the configuration component that are located within this region. Alternatively, it could indicate cells pointing to outside this region as exits, using a separate exit indicator signal (EXIT_STROBE) (123) or function to inform the configuration component when an exit (cell pointing out from the current region) is being examined. The traversal component could also have a separate means for indicating whether exits are to be indicated at all (105).

Another example would be a means for indicating whether self-contained cells (i.e., non-heap cells, or cells that do not contain a valid memory address) should be indicated to the configuration component (106).

There are also applications where it is sometimes desirable to traverse cells within an object in the reverse order from the order in which they are normally traversed (see e.g. U.S. Ser. No. 12/201,514). It is thus desirable in some embodiments of the present invention to have a means for selecting the direction of traversal (107) in the traversal component.

In many embodiments the traversal component can also provide other useful information to the configuration component at little extra computational cost. For example, it may determine the size of the current object (126) and pass that to the configuration object, so that it is readily available for e.g. allocating space for the copy of an object (or counting the size of a tree of objects, or incrementally calculating the amount of space needed for a group of objects). Another example is that the traversal component may track the old address of objects that are copied (and for which the traversal component is redirected to the new address), and provide this to the configuration means (125). This may be needed in some embodiments, such as for computing an index to the ‘WRBM’ bitmap when implementing the method of U.S. Ser. No. 12/201,514. The old address can be computed by saving the pointer to the old object in addition to the returned (redirected) object, and indexing it by the current cell index just as one would index the pointer to the current range. The pointer to the old object could be saved in the stack with the range.

One important aspect of traversing an object graph is detection of cycles and shared data structures. This can be performed on either side of the interface between the traversal component and the configuration component, depending on the embodiment.

While it would generally be preferable to perform it in the traversal component to maximize the reuse of the same logic, it tends to be a highly performance-critical element of the overall operations where traversal is used, and often (such as when using forwarding pointers during garbage collection) it can be achieved as a side product of something that would need to be done or recorded anyway. There is also variation as to whether it is enough to just detect cycles, in which case e.g. a bitmap covering the region being traversed may be sufficient. If also e.g. forwarding pointers or multiobject identifiers must be stored (and they cannot be stored or it is not desirable to store them in place of the original objects), then an array with larger elements may be used. In some cases the use of a hash table may be desirable.

The most effective method for performing cycle detection also depends on whether more than one thread may be processing the same memory region in parallel. In the case of more than one concurrent thread processing overlapping memory areas, something like atomic instructions (such as compare-and-swap) may be needed for cycle detection. These instructions are very expensive, often corresponding to more than a hundred ordinary instructions. The cost can usually be avoided if the control logic invoking the traversal component can guarantee that only one thread will be processing the memory area simultaneously. Making this selection efficiently within the traversal component would require implementing several mechanisms therein, and even then there would be extra overhead especially in software implementations.

It is thus preferable to perform cycle detection (including shared object detection) in the configuration object. It must be performed somewhere, but it can be in either the traversal component or in one or more configuration components.

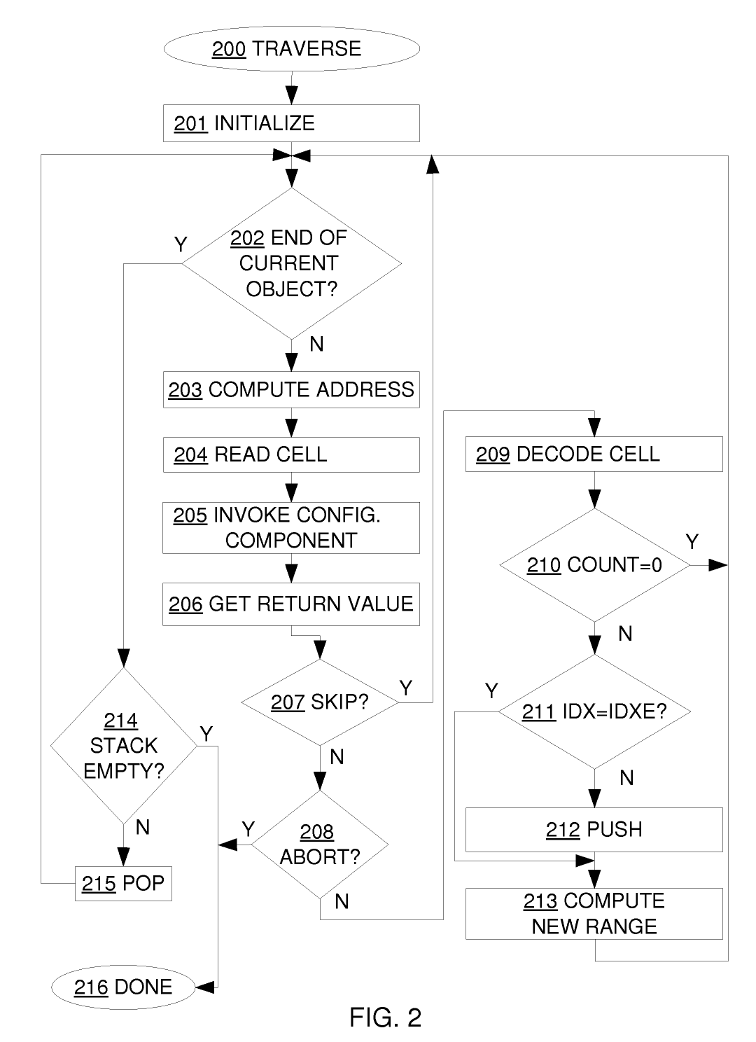

FIG. 2 illustrates the state machine of a possible embodiment of the traversal component. It is well known how to implement state machines in hardware, using either flip-flop chains or registers containing a state number. It is also well known how to implement state machines in software (whether representing the state number explicitly in a variable, whether coding it implicitly in the program counter register, or in some other way). The flow chart also illustrates a method of performing traversal. It is generally known in the art how to implement a traversal function for an object graph; however, the possibility of redirecting the traversal to a new object in a generic traversal function is not known in the prior art. Also, the ability to specify the traversal order for cells within an object appears new, and serves a useful purpose in multiobject garbage collection.

The traversal begins at (200). It is assumed that this embodiment takes as input a pointer to the initial cell (‘p’), direction of traversal (‘direction’, with e.g. 1 indicating left-to-right and '1 right-to-left). Additionally, the configuration component to use is selected; in a hardware implementation this could be done by configuring a multiplexer of some kind; in a software implementation an identifier (e.g., a function pointer) for the configuration object could be passed as argument.

It is assumed that the generic traversal mechanism has a stack memory area. In a hardware implementation this would preferably be a dedicated memory area within the traversal component. In a software implementation it could be in thread-local storage (passed to the traversal function e.g. in a thread-specific context structure, as a thread-local variable, or as an argument) or in the thread's stack. In the description it is assumed that the stack has a fixed maximum size; however, it would also be possible to use a stack with an overflow handling mechanism. A fixed size stack is particularly desirable in a hardware implementation, and the mechanisms described in U.S. Ser. No. 12/147,419 and U.S. Ser. No. 12/388,543 by the same inventor can be used to ensure that a fixed size stack suffices. In the preferred embodiment there is no need to support work stealing; however, embodiments incorporating work stealing are also possible.

At (201), various registers (or variables) are initialized. This may includes for example ‘sp’ (stack pointer), ‘idx’ (index to a cell within current object), and ‘idxe’ (limit index).

At (202), it is checked if all cells of the current range have already been processed. If not, execution continues to (203); if yes, then execution continues to (214), where it is checked whether the stack is empty, and if not, (215) pops a previous context (‘idx’, ‘idxe’, and ‘p’) from the stack and returns to (202). If the stack is empty, execution of the traversal completes at (216) and the completion is signaled to whatever triggered the traversal.

At (203) the address of the current memory cell is computed. In the preferred embodiment, it is ‘p+idx’. In other embodiments ‘p’ could point directly to the current cell, and an end pointer (limiting pointer) could be used instead of ‘idxe’ (a limiting index). The index is also advanced (typically by adding +1 or −1 to it, depending on direction).

At (204) the current cell is read from memory. This may involve whatever protocol and whatever delays would typically be associated with the memory interface (110) used.

At (205) the configuration component is invoked, passing control to it and suspending the traversal component until it indicates that the traversal component can continue. In a hardware implementation this can mean sending the cell and the address of the current cell to the configuration object, indicating availability of an object, and waiting for the configuration object to signal that it has completed processing the cell. In software this could mean a function or method call through a function pointer to the configuration object.

At (206) the return value is obtained from the configuration object. In the preferred embodiment it is the new cell to process (either the same one provided to the configuration object or a different one). It can also be a special invalid cell value, such as SKIP to skip the current cell (e.g. because it points to outside the current region), or ABORT (abort traversal). The SKIP value is checked at (207) and the ABORT value at (208).

From here on, “returned cell” shall mean the cell returned by the object function, or the original cell if the configuration component did not redirect it to a new address.

At (209) the returned cell is decoded to determine its size (including both pointer data and other fields), the offset at which the first cell containing a pointer is in the object, and the number of cells containing pointers. In some embodiments the entire object may always contain pointers, in which case the offset may be redundant. In other embodiments there may be cells containing pointers intermixed with cells containing other data types (e.g., floating point values). Alternatively, tagged cells may be intermixed with untagged raw values. In such cases the decode function can advantageously return a bitmap indicating which cells contain valid pointers (e.g., with the corresponding bit set to one if the cell contains a tagged value). Self-contained (e.g., small integers) would have size (and number of tagged cells) zero. The bitmap could be used to filter which cells to pass to the configuration object.

At (210) it is tested if the number of cells containing pointers (or tagged cells) is zero, and if so, traversing continues from (202) to process the next cell.

(211) tests if more cells remain in the current range. If so, it (preferably pointer, index, limit index) is pushed to the stack in (212).

At (213) a new pointer, index, and limit index are computed from the returned cell for traversing the cell we just decoded. The pointer may be directly the cell, or it may be computed from the cell e.g. by untagging it. The offset of the first pointer cell is added to it (alternatively, it could be added to the index and the limit index). For forward traversal, the index is preferably set to 0; for backward traversal, to ‘count −1’. The limit index is set to ‘count’ for forward traversal and to −for backward traversal. These define the new range, which will be used in next iteration.

It should be noted that many of the steps could be implemented in a different order or grouped differently. For example, in some embodiments decoding the cell (209) would advantageously be done before invoking the configuration object at (205), for example in cases where the configuration object should have access to the size of the object. Some or all of the steps may be implemented in hardware. A pointer could be advanced instead of index (eliminating ‘idx’). A limit pointer could be used instead of ‘idxe’.

In software, the traversal may be started by making a call to the machine instructions that implement the traversal component. The component may be implemented as a function call (possibly inlined), though a macro implementation is also possible. The preferred means for interfacing software components is a function call, and arguments can be used to pass and input the various signals and values to the function. The configuration component can be implemented as one or more function calls that are called by the generic traversal means. In one embodiment it provides just one function, which is called for each cell. In another embodiment it provides two function calls, one that is called for each object, and another that is called for each exit from the traversed region. The functions are passed as argument(s) to the generic traversal means, e.g. as function pointers in the C programming language, as a table or structure containing function pointers, or in some object-oriented languages as a configuration object that implements the interface functions as methods (in which they would typically be actually implemented as calls through a special call table, often called ‘vtable’). In some languages an object conforming to a defined interface specification would be used; however, the low-level implementation of these (as implemented by the compiler and run-time) is generally still a function pointer in some table or structure.

The following code illustrates the state machine of an embodiment of the traversal component when implemented in software (here, the state is represented implicitly by the program counter):

```
void traverse(ThreadLocalCtx ctx, Cell *p,
              int direction, ObjFn obj_fn)
{
  UInt32 sp = 0, idx = 0, idxe = direction;
  for (;;) {
    while (idx != idxe) {
      Cell *cellp = p + idx, cell = *cellp;
      idx += direction;
      UInt32 size = decode(ret, &ofs, &count);
      Cell ret = (*obj_fn)(cell, cellp, size);
      if (ret == SKIP) continue;
      if (ret == ABORT) return;
      if (count == 0) continue;
      if (idx != idxe) {
        ctx->stack[sp].p = p;
        ctx->stack[sp].idx = idx;
        ctx->stack[sp].idxe = idxe;
        sp++;
      }
      p = UNTAG(ret) + ofs;
      if (direction > 0)
        idxe = count, idx = 0;
      else
        idxe = −1, idx = count − 1;
    }
    if (sp == 0)
      return;
    sp−−;
    p = ctx->stack[sp].p;
    idx = ctx->stack[sp].idx;
    idxe = ctx->stack[sp].idxe;
  }
}
```

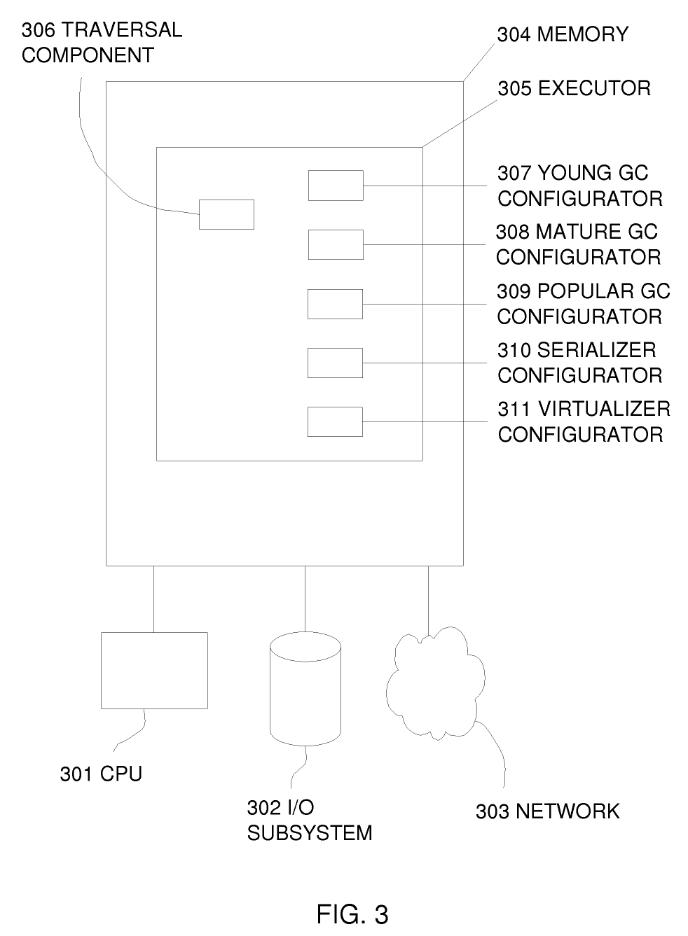

FIG. 3 illustrates a computer system according to a possible embodiment of the present invention. (301) represents one or more processors, (302) represents the I/O subsystem, including storage (e.g., flash memory, magnetic disk, optical storage, networked storage), (303) represents a data communications network (such as the Internet, a cluster interconnect, or a wireless network), (304) represents the main memory of the computer system comprising one or more memory devices (such as SRAM or DRAM).

(305) represents the executor framework on the computer. It may be e.g. a virtual machine such as a Java virtual machine, Lisp runtime, web application framework, an operating system, or other framework for executing applications. The executor comprises a garbage collection means that needs to traverse an object graph in main memory at more than one place.

(306) represents a configurable traversal component in the computer. It may be either a hardware component as part of an executor ASIC, or it may be a procedure implemented in machine executable program code stored in the computer's memory that causes it to traverse the object graph as directed by a configuration means.

The computer also comprises a number of configuration means. In this particular embodiment, (307) is a configuration component for performing young generation garbage collection (several different configuration components could be used in an actual young generation collector—for example, our implementation of multiobject garbage collection uses four different configuration components to implement young generation collection), (308) represents a configuration component for mature generation collection (our multiobject collector has three), (309) represents a configuration component for implementing popular object collection, (310) represents a configuration component for implementing serialization, and (311) represents a configuration component for implementing a distributed persistent storage system.

An aspect of the present invention is a machine comprising at least one configurable traversal component for traversing an object graph stored in one or more memory devices, the component comprising:
a means for starting the traversal
a means for inputting the initial cell
an interface for signaling from the traversal component to at least one configuration component, the interface comprising:
   a means for passing the memory address of the cell currently being examined, and
   a means for indicating when the address is valid;
an interface for signaling from at least one configuration component to the traversal component, the interface comprising:
   a means for indicating that traversing can continue by recursing into the current cell
   a means for indicating that traversing can continue by skipping the current cell
   a means for redirecting the traversal to a cell other than the one received from the traversal component;
a means for reading information from the memory devices in which the object graph is stored; and
a means for indicating when the traversal is complete.

The machine according to the present invention is preferably a computer or a mobile computing device, but can be any machine comprising a computing device, such as a robot, vehicle, or a complex computing system such as an information retrieval system, network server, or a clustered computer system comprising many computing nodes. The traversal component itself is implemented in a computing device within the machine; the computing device may be special hardware (such as an ASIC) and/or may use one or more general purpose processors.

Another aspect of the present invention is a method of traversing an object graph stored in one or more memory devices in a computing device, the method comprising:
inputting the initial cell to be traversed to a traversal component
initializing, by the traversal component, a range from the initial cell
while unprocessed cells remain in the range, performing the following steps repeatedly by the traversal component:
   computing the address of the current cell to traverse and reading the current cell
   invoking a configuration component, and supplying the current cell and its address to the configuration component
   obtaining a new address to which traversal is to be redirected from the configuration component
   if the new address is a special value indicating that the current cell should not be traversed, continuing with the next cell
   pushing the current range on stack if it still contains unprocessed cells
   computing a new range from the new address returned by the configuration component; and
while the stack is not empty, popping a range from the stack and repeating the above step.

The new address refers to the returned cell; it may be either a cell or an address or something from which the address can be computed.

A further aspect of the present invention is computer readable medium having a computer program embodied therein, the computer program operable to control a computing device to perform:
inputting the initial cell to be traversed
initializing a range from the initial cell
while unprocessed cells remain in the range:
   computing the address of the current cell to traverse and reading the current cell
   invoking a configuration component, and supplying the current cell and its address to the configuration component
   obtaining a new address to which traversal is to be redirected from the configuration component
   if the new address is a special value indicating that the current cell should not be traversed, continuing with the next cell
   pushing the current range on stack if it still contains unprocessed cells
   computing a new range from the new address returned by the configuration component; and
while the stack is not empty, popping a range from the stack and repeating the above step.

Many variations of the above described embodiments will be available to one skilled in the art without deviating from the essence of the invention as set out herein and in the claims. In particular, some operations could be reordered, combined, or interleaved, or executed in parallel, and many of the data structures could be implemented differently.

It is to be understood that the aspects and embodiments of the invention described herein may be used in any combination with each other. Several of the aspects and embodiments may be combined together to form a further embodiment of the invention. A method, a computer system, or a computer readable medium which is an aspect of the invention may comprise any number of the embodiments or elements of the invention described herein.

What is claimed is:

1. A machine comprising: at least one configurable traversal component for traversing an object graph stored in one or more memory devices, the component comprising:
a means for starting the traversal
a means for inputting the initial cell
an interface for signaling from the traversal component to at least one configuration component, the interface comprising:
a means for passing the memory address of the cell currently being examined, and
a means for indicating when the address is valid;
an interface for signaling from at least one configuration component to the traversal component, the interface comprising:
a means for indicating that traversing can continue by recursing into the current cell
a means for indicating that traversing can continue by skipping the current cell
a means for redirecting the traversal to a cell other than the one received from the traversal component;
a means for reading information from the memory devices in which the object graph is stored; and
a means for indicating when the traversal is complete.

2. The machine of claim 1, wherein at least one configuration component comprises a cycle detection means.

3. The machine of claim 1, wherein at least one traversal component further comprises:
a means for inputting the start address and size of the memory region to traverse, and
a means for indicating to the configuration component when an exit from the region being traversed is encountered.

4. The machine of claim 1, wherein at least one traversal component further comprises:
a means for indicating in which direction to traverse the cells within each object.

5. The machine of claim 1, wherein at least one traversal component further comprises:
a means for indicating whether non-heap cells should be indicated to the configuration component.

6. The machine of claim 1, wherein at least one traversal component further comprises:
a means for indicating the size of the current cell to the configuration means.

7. The machine of claim 1, wherein at least one traversal component further comprises:
a means for indicating to the configuration component the old address of a cell in an object that has been redirected to a new address.

8. The machine of claim 1, wherein the stack of at least one traversal component has fixed size.

9. The machine of claim 1, wherein the traversal component is implemented at least partially in semiconductor logic.

10. The machine of claim 1, wherein the stack is semiconductor memory embedded within the traversal component.

11. The machine of claim 1, wherein the traversal component is implemented at least partially in computer executable software stored in one or more memory devices in the machine.

12. A method of traversing an object graph stored in one or more memory devices in a computing device, the method comprising:
inputting the initial cell to be traversed to a traversal component
initializing, by the traversal component, a range from the initial cell
while unprocessed cells remain in the range, performing the following steps repeatedly by the traversal component:
computing the address of the current cell to traverse and reading the current cell
invoking a configuration component, and supplying the current cell and its address to the configuration component
obtaining a new address to which traversal is to be redirected from the configuration component
if the new address is a special value indicating that the current cell should not be traversed, continuing with the next cell
pushing the current range on stack if it still contains unprocessed cells
computing a new range from the new address returned by the configuration component; and
while the stack is not empty, popping a range from the stack and repeating the above step.

13. The method of claim 12, wherein also the size of the object denoted by the current cell is supplied to the configuration component.

14. A computer readable medium having a computer program embodied therein, the computer program operable to control a computing device to perform:
inputting the initial cell to be traversed
initializing a range from the initial cell
while unprocessed cells remain in the range:
computing the address of the current cell to traverse and reading the current cell
invoking a configuration component, and supplying the current cell and its address to the configuration component
obtaining a new address to which traversal is to be redirected from the configuration component
if the new address is a special value indicating that the current cell should not be traversed, continuing with the next cell
pushing the current range on stack if it still contains unprocessed cells
computing a new range from the new address returned by the configuration component; and
while the stack is not empty, popping a range from the stack and repeating the above step.
